(19) United States
(12) Patent Application Publication
(10) Pub. No.: US 2023/0419263 A1
(43) Pub. Date: Dec. 28, 2023

(54) PROJECT DATA VISUALIZATION AND MANAGEMENT SYSTEM

(71) Applicant: United States Postal Service, Washington, DC (US)

(72) Inventors: Jason D. HEWITT, Gastonia, NC (US); Isabel L. NAVARRO, Arlington, VA (US)

(21) Appl. No.: 17/847,518

(22) Filed: Jun. 23, 2022

(51) Int. Cl. G06Q 10/10; G06Q 10/06; G06F 16/26

(52) U.S. Cl. CPC G06Q 10/103; G06Q 10/06; G06F 16/26

(57) ABSTRACT

Systems, methods, and devices for displaying project data implement operations that include receiving multi-level project data originating from a plurality of disparate data sources associated with different entities within an organization. The project data may include information identifying initiatives or tasks performed by the different entities. The operations further include storing the project data, which may be standardized, in a central repository; determining connections and/or alignments between the initiatives within the organization based on the stored project data; and displaying information identifying the determined connections and alignments between the initiatives, which typically span across multiple levels within the organization. The information may be graphically displayed on a single interface.

### BACKGROUND

Hoshin Kanri is a strategic planning process in which strategic goals are communicated throughout the company and then put into action. Hoshin Kanri is a top-down approach, with goals and objectives being mandated by management and the implementation being performed by employees.

Hoshin Kanri involves defining strategic objective over different time frames (e.g., one to five-year time frames). Effective planning includes focusing on vital goals that are deemed to be strategically important. Larger goals may be broken down into smaller goals and implemented so that personnel at various levels agree on what tasks to be accomplished. Hoshin Kanri may further involve tracking progress and performance measurements.

### SUMMARY

In one example aspect, a computer-implemented method for displaying multi-level project data is presented herein, and the computer-implemented method includes various operations described herein. In another example aspect, a computer program product for displaying multi-level project data is presented herein, the computer program product includes a computer readable storage medium having program instructions embodied therewith, and the program instructions are executable by a computing device to cause the computing device to perform various operations described herein. In yet another example aspect, a system for displaying multi-level project data is presented herein, and the system includes a processor, a computer readable memory, a non-transitory computer readable storage medium associated with a computing device, and program instructions executable by the computing device to cause the computing device to perform various operations described herein.

In various implementations associated with the method, the computer program product, and/or the system, operations are included for receiving multi-level project data originating from a plurality of disparate data sources associated with a plurality of different entities within an organization, wherein the multi-level project data comprises information identifying initiatives performed by the plurality of different entities; storing the multi-level project data in a data structure in a central repository; determining connections and alignments between the initiatives across multiple levels within the organization based on the stored multi-level project data; and displaying information identifying the determined connections and alignments between the initiatives across the multiple levels within the organization.

In some implementations, displaying the information identifying the determined connections and alignments includes displaying an organization-wide strategic plan developed using a Hoshin Kanri strategic planning process. In some implementations, displaying the information identifying the determined connections and alignments includes displaying a Sankey diagram illustrating the determined connections and alignments.

In various implementations, the operations further include receiving user inputs for filtering the multi-level project data based on one or more attributes; and dynamically modifying an appearance of the Sankey diagram based on the user inputs.

In various implementations, the operations further include receiving a user input that includes a selection of a data point included in the multi-level project data; and presenting additional information regarding the data point.

In various implementations, the operations further include standardizing the multi-level project data, and storing the multi-level project data in the data structure includes storing the standardized multi-level project data.

In various implementations, the data structure includes information identifying the connections and alignments between the initiatives across multiple levels within the organization, and that information includes at least one of: an initiative name; funding information; a group name; a roadmap identifier; a value type; a metric; status information; or owner information.

### BRIEF DESCRIPTION OF THE DRAWINGS

FIG. 1 illustrates an overview of an example environment and implementation in accordance with aspects of the present disclosure.

FIG. 2 illustrates a block diagram of example components of a data management and presentation system in accordance with aspects of the present disclosure.

FIG. 3 illustrates an example flowchart of a process for consolidating and presenting multi-level project data originating from disparate sources to visualize the connections and alignments between initiatives across a multi-level or multi-layer organization.

FIGS. 4A and 4B illustrate an example of a graphical user interface (GUI) used to input project data.

FIG. 5 illustrates an example data structure that stores consolidated project data.

FIG. 6 illustrates an example of a graphical user interface (GUI) for presenting multi-level project data in accordance with aspects of the present disclosure.

FIG. 7 illustrates example components of a device that may be used within environment of FIG. 1.

### DETAILED DESCRIPTION

Large organizations (e.g., companies, corporations, government entities, etc.) may include different entities or sub-entities (e.g., personnel, departments, groups, subsidiaries, etc.) scattered across various locations, chain of commands, etc. Different entities or sub-groups may maintain different sets of project data, such as strategic plans, goals/objectives, progress information, schedules, etc. As a result, project data across multiple levels in different chains of commands may be in different or incompatible formats and originate from various disparate and/or isolated systems, sources, or entities, thereby diminishing or preventing the effort to align initiatives (e.g., tasks) and strategic objectives from higher level management across lower levels in an organizational hierarchy.

Hoshin Kanri and other conventional strategic planning systems may attempt to align initiatives across multiple levels in an organization, however, strategic planning is often deficient or unworkable as a result of the disparate source data from which strategic planning is executed. For example, different entities or groups in an organization may maintain their own strategic plans (e.g., developed with Hoshin Kanri or other strategic planning processes), but initiatives and tasks within these strategic plans may not fully align with overall strategies and goals of the organization as a whole.

Accordingly, aspects of the present disclosure may include a system, device, and/or method that consolidates, centralizes, normalizes, and/or standardizes multi-level project data spanning across an organization, where the project data may originate from numerous disparate and/or isolated sources, in contrast to current conventional systems, which do not have the technical capability to share, consolidate, or standardize project data. As described herein, aspects of the present disclosure may consolidate and/or standardize any variety of project data relating to a project initiative (e.g., project task), connections/dependencies between the initiative and other initiatives, initiative owners/stakeholders, completion status of the initiative, goals/objectives linked to the initiative, and/or any other variety of attributes or information associated with the initiative. By consolidating and structuring the project data in the manner described herein, objectives from higher levels in the organization are effectively communicated down the chain of command.

Aspects of the present disclosure may further include a novel interactive project data visualization and management tool that visually presents multi-level project data that has been received, consolidated and/or standardized using the techniques described herein. This is novel in contrast to the technical capabilities of current conventional systems, which don't share, consolidate, standardize, or jointly display project data. As one example, aspects of the present disclosure may visually present or display, e.g., on a GUI, an organization-wide strategic plan (e.g., developed using one or more separate Hoshin Kanri processes and/or other strategic planning processes) across different sections of the organization. This novel visual representation or display improves user comprehension, displays data more efficiently in the limited screen space using graphic representations, and makes it possible for a user (e.g., a high level manager) to see more data at the same time, which provides a “big picture” to perform strategic project planning, project status reporting, and/or team communication based on accurate data obtained from multiple sources across an organization.

For example, the novel, improved visual representation or display of multi-level project data may be used to align tasks and initiatives performed by different levels of an organization such that the tasks performed align with the overall objectives of the organization. Additionally, or alternatively, the visual representation may be used to identify tasks and initiatives that may not be aligned with the overall objectives of the organization and modify the initiatives in an overall strategic plan to better align the initiatives with the objectives. As a result, project efficiency and/or project resource allocation may be improved (e.g., by reducing duplication of efforts among team members, improving strategic plan development, and improve resource allocation to focus resources and initiatives on those that drive value). Further, project metrics (e.g., indicating measures of project success) may be improved as a result of the improved project strategic plan developments.

As described herein, the project data visualization and management tool provides an interactive interface and dynamically updates and modifies the visual representation of multi-level project data based on interactive user inputs received from a user. As an illustrative example, the project data visualization and management tool allows a user to modify filters and other variables to adjust the visualization of the multi-level project data based on areas of interest. Also, the project data visualization and management tool allows a user to “drill down” on a node or data point (e.g., initiative or task) to obtain further information on linked sub-nodes (e.g., sub-initiatives) or underlying data points and gain additional insights on a sub-entity's (e.g., a department's) contributions to a composite or higher level (e.g., organization-wide) initiative. In contrast, existing conventional systems use static representations that fail to take into account dynamically changing variables and dynamically changing areas of interest.

In some embodiments, the project data visualization and management tool, in accordance with aspects of the present disclosure, may be used to improve any variety of strategic planning and communication processes, such as Hoshin Kanri and/or other types of planning processes. Additionally, or alternatively, the project data visualization and management tool, described herein, may be integrated or used in conjunction with Hoshin Kanri and/or other planning processes to study, improve, develop, and/or evolve an organization strategic plan in which initiatives at various levels and layers of the organization are aligned. For example, the project data may include one or more different strategic plans developed by different entities in an organization (e.g., developed using a Hoshin Kanri process and/or other type of strategic planning process). The project data visualization and management tool may consolidate the various strategic plans developed by different entities in an organization, and visually represent or display the different plans in one meaningful visualization interface, instead of in several different displays as is done by conventional systems. Further, the project data visualization and management tool may present project data in a variety of graphics, formats and styles. In some embodiments, the project data may be presented in the form of a Sankey diagram in which the user may view the connections between an initiative and how the initiative aligns with different areas of the organization, groups, strategies, goals/objectives. That is to say, the project data visualization and management tool may present a company or organization-wide strategic plan, derived from individual group plans and project data and developed using a Hoshin Kanri process, in the form of a Sankey diagram which presents a visualization showing whether the initiatives are aligned and the value of the contributions for each initiative to multi-level goals. Additionally, or alternatively, the project data visualization and management tool may present or display project data in any other of a variety of formats in which the project data may be represented by various sub-entities across an organization and may originate from numerous disparate and/or isolated sources (e.g., databases, repositories, applications, etc.) and that may originate in various formats and structures.

In some embodiments, the project data visualization and management tool, in accordance with aspects of the present disclosure, may present a number of data points (e.g., initiatives) and the connections between the initiatives across different levels in an organization. In this way, the impact, and value added by each initiative across the different levels (e.g., different groups, strategies, correlations, etc.) may be visualized and identified in one display.

In some embodiments, the project data visualization and management tool may include an interactive interface via which a user may provide user inputs to generate a customizable view of multi-level project data. In some embodiments, the user inputs may include instructions to filter the multi-level project data by different attributes and connections between organizations, groups, strategy types, goals, objectives, etc. In some embodiments, user inputs may include: instructions to view connections between initiatives across various layers of an organization (e.g., in the form of a Sankey diagram), instructions to view the details of an initiative (e.g., an initiative relating to a type of service provided by the organization), and instructions to “drill down” to view contributions and progress made by various groups involved in that initiative, as well as other attributes and/or details of the initiative (e.g., groups, owners, stakeholders of the initiatives, objectives of the initiative, progress completion of the initiative, etc.). In this way, the project data visualization and management tool may assist with strategic plan development by providing a single system/display where a user can identify tasks that align with overall organization objectives and focus on tasks that drive value, and also identify the value contributed by various initiatives and layers in an organization. Further, the project data visualization and management tool provides an interactive interface to view project data from different angles and with different filters applied, for example, to assist with developing a strategic plan that focuses on areas that may be underperforming and/or misaligned with cross-organizational objective.

In some embodiments, the project data visualization and management tool may structure and/or organize multi-level strategic planning project data within a novel data structure. The project data may be structured in a manner that identifies initiatives, their attributes, values, and connections to other entities, levels, and/or layers within the organization. As further described herein, the data stored in the data structure may be filtered and visually represented or displayed in a Sankey diagram to allow single-display visualization and strategic planning to further study, improve, and/or develop a strategic plan (e.g., using a Hoshin Kanri process and/or other strategic planning process). That is, the manner in which the project data is consolidated, structured, and/or standardized makes it possible to better visualize how different initiatives are linked or connected, and how they align with higher-level and/or organization wide initiatives, goals, and objectives.

As described herein, aspects of the present disclosure may consolidate and standardize multi-level project data that is stored or exists in different formats and originates from disparate sources. Using the consolidated, standardized multi-level project data, aspects of the present disclosure may produce an improved, meaningful visual representation or display of connections between initiatives and different departments, as well as their status/performance and alignment to other departments and overall organization objectives. In contrast, existing conventional systems require numerous, time-consuming requests to obtain data from various computing databases and repositories to obtain the various project data (e.g., spreadsheets, Hoshin Kanri plans, etc.), in various formats from different layers and departments in an organization. The data must then be manually sifted and interpreted in order to gain an understanding of a particular initiative's contribution and value to an overall organizational strategic plan. The slow requests and manual processes consume large amounts of computing processes, time, and resources before the received data can be applied into different workflows for analysis, display, and use. By using the project data visualization and management tool in accordance with aspects of the present disclosure, the amount of computing resources required to display a meaningful visual representation of multi-level project data is significantly reduced in comparison with existing techniques and systems, and manual processes are eliminated. For example, aspects of the present disclosure eliminate the need to provide requests for different data, which increases speed and decreases bandwidth usage, and further eliminate the need to apply the data to various conventional workflows that produce inaccurate visualizations of data. Further, aspects of the present disclosure may present a company or organization-wide strategic plan, derived from individual group plans and project data and developed using a Hoshin Kanri process, in the form of a Sankey diagram that illustrates connections between initiatives and displays how the initiatives align with each other for different areas/entities of the organization, groups, strategies, and goals/objectives. By using and automating the Sankey diagram, as described herein, various aspects of the present disclosure eliminate the need to provide requests for different data, and further eliminate the need to apply the data to various workflows to identify the connections between initiatives and how the initiatives align with each other in different areas of the organization.

Certain embodiments of the disclosure will hereafter be described with reference to the accompanying drawings, wherein like reference numerals generally denote like elements. It should be understood, however, that the accompanying drawings illustrate only the various implementations described herein and are not meant to limit the scope of various technologies described herein. The drawings show and describe various embodiments of the current disclosure.

Embodiments of the disclosure may include a system, a device, a method, and/or a computer program product at any possible technical detail level of integration. The computer program product may include a computer readable storage medium (or media) having computer readable program instructions thereon for causing a processor to carry out aspects of the present disclosure.

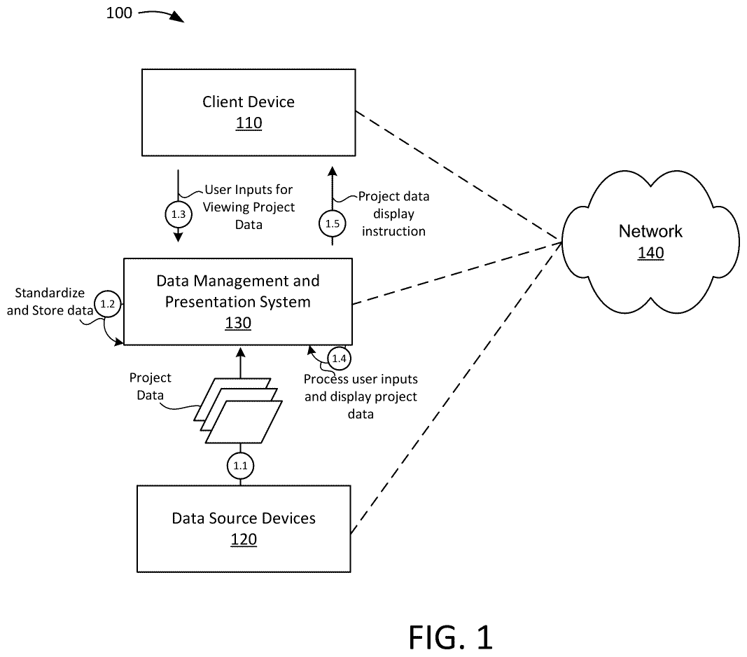

FIG. 1 illustrates an overview of an example of an environment and implementation in accordance with aspects of the present disclosure. As shown in FIG. 1, the environment 100 includes a client device 110, one or more data source devices 120, a data management and presentation system 130, and a network 140.

The client device 110 may be or include a computing device capable of communicating via a network, such as the network 140. In example embodiments, the client device 110 corresponds to a portable computer device (e.g., a laptop computer), a desktop computer, a server device, and/or another type of computing device. In some embodiments, the client device 110 may be used by a user (not shown) to provide user inputs to the data management and presentation system 130 and to view displayed project data (e.g., via an application, a web-based portal, a GUI, or the like). As described herein, examples of user inputs may include inputs to filter the project data according to different attributes, and instructions to: view an initiative or task (e.g., an initiative or task relating to a type of service provided by the organization), “drill down” to view contributions and progress made by various groups involved in that initiative, view the project data in different formats, etc. The client device 110 may receive project data display instructions generated based on the user input and display the project data (e.g., within an application, webpage, etc. via a GUI).

The data source device(s) 120 may include one or more computing devices that store and/or maintain project data (e.g., from various levels, layers, or departments from within an organization). In various embodiments, the project data may be disparate and/or in different formats that are not be compatible with each other (e.g., spreadsheets, arrays, tables, graphs, Hoshin Kanri plans, etc.). In some embodiments, the data source devices 120 may be isolated and/or from disparate from each other.

The data management and presentation system 130 may be or include one or more computing devices. In various embodiments, the data management and presentation system 130 consolidates, centralizes, normalizes, translates, and/or standardizes project data received from the data source devices 120. For example, the data management and presentation system 130 may host a platform or application that obtains and consolidates project data across an organization and from disparate and/or isolated departments and sources such that all of the consolidated project data from across the organization is usable by the data management and presentation system 130. In some embodiments, the data management and presentation system 130 may host an application to receive user inputs (e.g., commands or instructions) for viewing and interacting with the consolidated project data. The data management and presentation system 130 may process and/or execute the user inputs to generate and/or display various views and visual representations of the project data. In various embodiments, the views and visual representations may be presented or displayed to a user via a GUI on the screen of the client device 110. In some embodiments, the data management and presentation system 130 may refresh different visual representations when it receives subsequent user inputs and/or new or additional data from a data source device 120. Additionally, or alternatively, the data management and presentation system 130 may generate and/or display default views of the consolidated project data without receiving user input.

In various embodiments, the network 140 may include network nodes (not shown) and one or more wired and/or wireless networks (not shown). For example, the network 140 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 140 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the network 140 may include copper transmission cables, optical transmission fibers, wireless transmission, routers, firewalls, switches, gateway computers and/or edge servers.

The quantity of devices and/or networks and their connections to each other in the environment 100 is not limited to what is shown in FIG. 1. In practice, the environment 100 may include additional devices and/or networks; fewer devices and/or networks; different devices and/or networks; or differently arranged devices and/or networks than illustrated in FIG. 1. Also, in some implementations, one or more of the devices of the environment 100 may perform one or more functions described as being performed by another one or more of the devices of the environment 100. Devices of the environment 100 may interconnect via wired connections, wireless connections, or a combination of wired and wireless connections.

As represented by the arrow 1.1 shown in FIG. 1, the data management and presentation system 130 may receive or otherwise obtain project data from one or more of the data source devices 120. In some embodiments, the data management and presentation system 130 may obtain the project data on a push or pull basis via which the project data may be provided to the data management and presentation system 130 on an intermittent or regular basis. Additionally, or alternatively, the project data may be inputted by a user. For example, the data management and presentation system 130 may host an application for inputting the project data. In some embodiments, the application may receive the project data as a file and may import the project data into the data management and presentation system 130. In this way, different entities, layers, and departments in an organization may use the data management and presentation system 130 to centrally hold their various project data (or a copy thereof), which may be multi-level or multi-layer project data, thereby mitigating any issues arising from each of the data source devices 120 creating and/or maintaining data that is disparate from the data of other entities (e.g., departments) in an organization and/or isolated from (e.g., inaccessible by or unavailable to) the other entities.

As further shown by the arrow 1.2, the data management and presentation system 130 may standardize, translate, normalize and/or otherwise consolidate and centrally store the project data. For example, the data management and presentation system 130 may use an adapter or translator to convert the project data from the format/structure used by a data source device 120 into a standardized format and/or structure. In some embodiments, the project data may be initially generated in the desired standardized format by one or more of the data source devices 120, which can reduce or eliminate the need for the data management and presentation system 130 to convert the project data into standardized project data. In some embodiments, the project data may be initially stored within repositories/databases associated with the data source devices 120. Additionally, or alternatively, the project data may be inputted by a user.

As further represented by the arrow 1.3, the data management and presentation system 130 may receive user inputs for viewing the standardized project data from the client device 110. For example, the data management and presentation system 130 may host an application (e.g., a data management and presentation application) that includes an interface to receive the user inputs 1.3. In some embodiments, the client device 110 may access or interface with the application and provide the user inputs 1.3 entered by a user. As described herein, examples of user inputs may include inputs to filter the standardized project data according to different attributes, instructions to view an initiative (e.g., an initiative relating to a type of service provided by the organization), instructions to “drill down” to view contributions and progress made by various groups involved in that initiative, instructions to view the standardized project data in different formats (e.g., a Sankey Diagram), etc.

In various embodiments, the data management and presentation system 130 may process the user inputs and generate or create a specific type of display for the standardized project data based on the user inputs—for example, the data management and presentation system 130 may create a graphical type of display that shows the standardized project data in a manner that visually shows the connections and alignments between the initiatives within an organization. In some embodiments, e.g., as represented by the arrow 1.4, the data management and presentation system 130 may provide (e.g., display) the project data to the user via a website, monitor, screen, or the like associated with the data management and presentation system 130. In other embodiments, e.g., as represented by the arrow 1.5, the data management and presentation system 130 may send instructions, information, or the like to the client device 110 (e.g., to an application executing on the client device 110), such that the client device 110 displays the project data to the user.

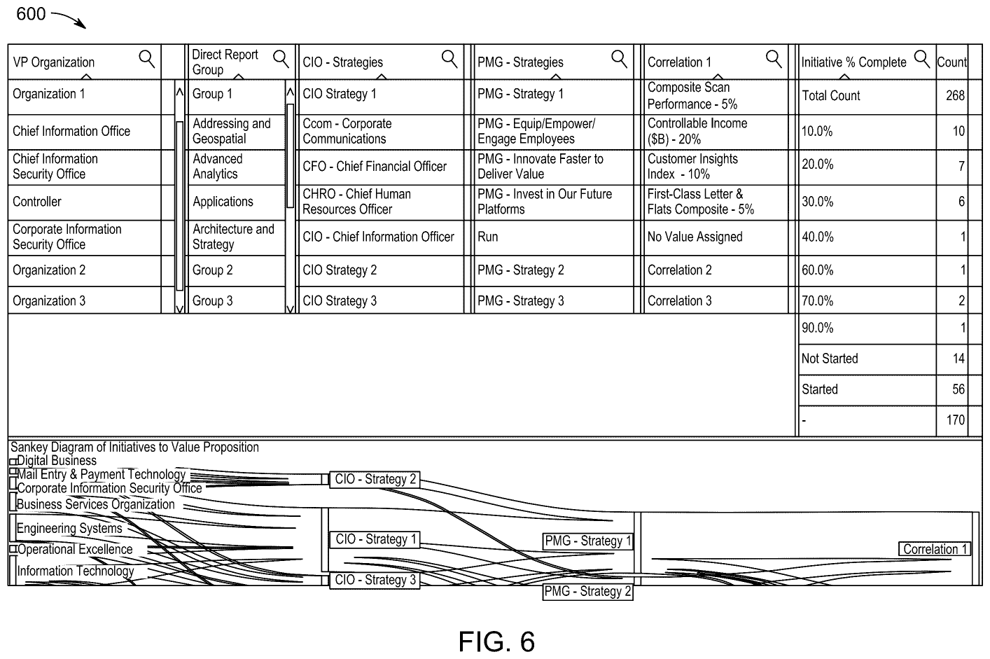

In various embodiments, the data management and presentation system 130 may execute the instructions included in the user inputs 1.3 to present the standardized project data in a manner specified by the user inputs. For example, the data management and presentation system 130 may present the standardized project data in the form of a graphical Sankey diagram in which the user may view the connections between an initiative and how the initiative aligns with different areas of the organization, groups, strategies, goals/objectives, etc. Thus, in some embodiments, the data management and presentation system 130 may present a company or organization-wide strategic plan, derived from individual group plans and project data and developed using a Hoshin Kanri process, in the form of a Sankey diagram that illustrates connections between initiatives and how the initiatives align with each other in different areas of the organization, groups, strategies, and goals/objectives. An example of a Sankey diagram is presented and discussed in further detail with respect to FIG. 6.

In some embodiments, operations 1.3, 1.4 and/or 1.5 may be repeated as the user interactively provides additional inputs to modify the manner in which the project data is presented or displayed. For example, the user may provide user inputs to filter the project data by different attributes, to view the progress of initiatives across different areas in the organization, to select an initiative and further study the initiative's value and alignment with the overall organization-wide objectives, etc. In this way, misaligned initiatives producing relatively low value to the overall organization objectives may be easily identified and addressed.

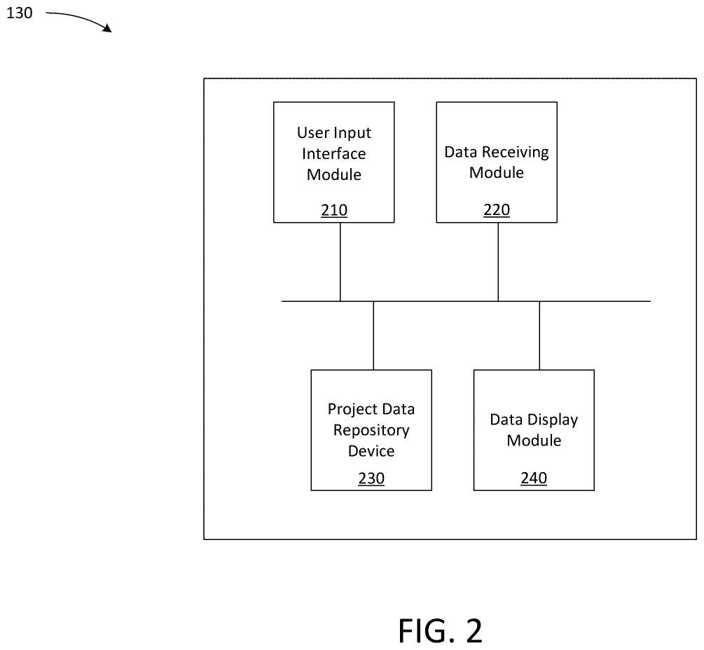

FIG. 2 illustrates a block diagram of example components of a data management and presentation system 130 in accordance with aspects of the present disclosure. As shown in FIG. 2, the data management and presentation system 130 includes a user input interface module 210, a data receiving module 220, a project data repository device 230, and a data display module 240. In other embodiments, the data management and presentation system 130 may include additional or fewer components than those shown in FIG. 2. In various embodiments, separate components shown may be integrated into a single computing component or module. Additionally, or alternatively, a single component shown may be implemented as multiple computing components or modules.

In various embodiments, the user input interface module 210 may generate, display, or otherwise present a user interface associated with the data management and presentation system 130 and receive user inputs for generating various views or displays of project data (e.g., via the client device 110). Additionally, or alternatively, the user input interface module 210 may receive or otherwise obtain user inputs of manually inputted project data (e.g., through a form). In some embodiments, the user input interface module 210 may present the user interface via an application, a web page, or the like. In some embodiments, the user input interface module 210 may authenticate a user before the system 130 permits the user to access the system 130 and its associated data.

In various embodiments, the data receiving module 220 may receive or obtain project data from the data source devices 120. In some embodiments, project data may be received in two or more different formats (e.g., spreadsheets, tables, comma separated values, Hoshin Kanri plans, etc.). In some embodiments, the project data may be received from isolated and/or disparate data source devices 120 that are used by different entities and groups and located at different locations in an organization. In some embodiments, the data receiving module 220 may receive the project data on a push or pull basis such that the project data may be provided to the data receiving module 220 on an intermittent or regular basis. Additionally, or alternatively, the project data may be inputted by a user (e.g., via the user input interface module 210).

In various embodiments, the project data repository device 230 may include one or more databases, data structures, storage devices, and the like that store project data (e.g., received by the data receiving module 220). In various embodiments, the project data repository device 230 may consolidate and/or centralize an organization's overall project data in a single location (or in a virtual single location (e.g., a cloud storage location)), even though the subsets or parts of the overall project data were originated by several disparate data source devices 120. In various embodiments, the project data repository device 230 may structure, normalize, translate or otherwise standardize the project data and store the standardized project data, e.g., in a data structure that supports the graphic displays described herein.

In various embodiments, the data display module 240 may generate signals and/or instructions for displaying the project data, which is typically standardized before being processed for display. In some embodiments, the data display module 240 may display the project data according to input (e.g., parameters) received from a user (e.g., via the user input interface module 210). For example, the data display module 240 may filter, organize, and/or present the project data based on the user input received via the user input interface module 210 in conjunction with an application and/or web portal or web page. The data display module 240 may generate display instructions or signals based on the user input to display the project data via the client device 110 (e.g., via an application, web-portal, or the like). As one illustrative example, the standardized project data may be presented in the form of a Sankey diagram that enables the user to view the connections between an initiative and how the initiative aligns with the goals, strategies, and objectives associated with different areas and sub-entities of the organization. Further, the user may provide a stream of user inputs in an interactive session to cause changes in the display and further study the graphical connections between initiatives.

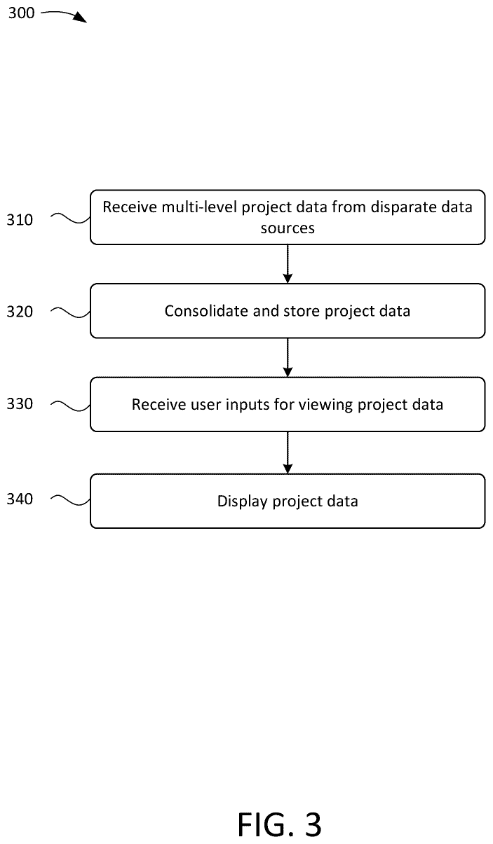

FIG. 3 illustrates an example of a flowchart for a process 300 for consolidating and presenting multi-level project data originating from disparate sources to visualize and connections and alignments between initiatives across a multi-level or multi-layer organization. In some embodiments, the process 300 may be used to visualize (e.g., graphically display on a monitor) a strategic plan developed for a multi-level or multi-layer organization (e.g., developed using a Hoshin Kanri process and/or other strategic planning process). The blocks (e.g., operation, functions, and/or instructions) of FIG. 3 may be implemented in the environment of FIG. 1, for example, and are described using the reference numbers of elements depicted in FIG. 1. As noted herein, the flowchart shown illustrates the architecture, functionality, and operation of possible implementations of systems, methods, and computer program products according to various embodiments of the present disclosure.

As shown in FIG. 3, the process 300 may include receiving or otherwise obtaining multi-level project data from disparate data sources (block 310). For example, as described above with respect to the data receiving module 220, the data management and presentation system 130 may receive project data 1.1 from the data source devices 120. In some embodiments, the project data from different data source devices 120 may be in different formats (e.g., spreadsheets, Hoshin Kanri plans, integer, floating point, text, etc.). In some embodiments, the project data may be received from isolated and/or disparate data source devices 120 that are associated with (e.g., used by) various entities in different locations in an organization. In some embodiments, the data receiving module 220 may receive the project data on a push or pull basis in which project data may be provided to the data receiving module 220 on an intermittent or regular basis.

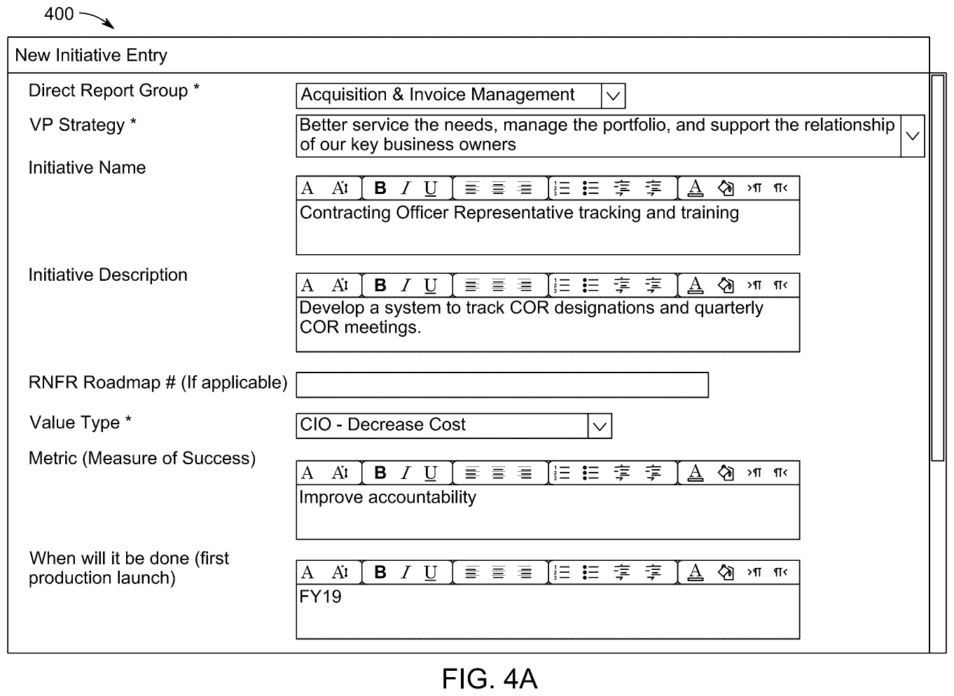

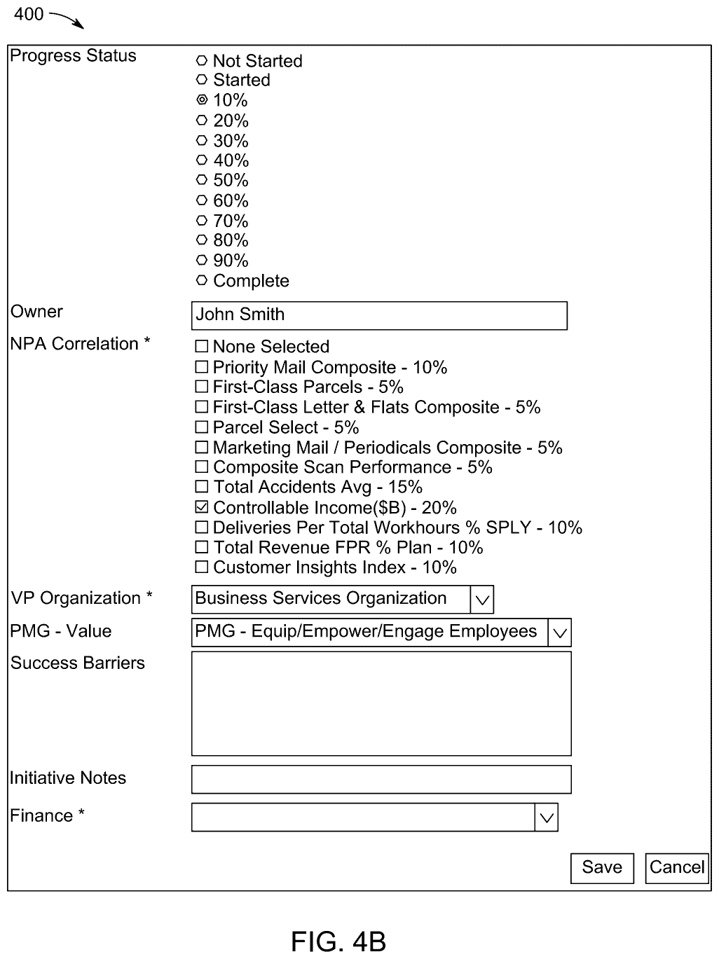

In some embodiments, some or all of the multi-level project data may be inputted by one or more user(s) (e.g., via the user input interface module 210). For example, project data or information may be inputted by a user via a form (e.g., an HTML or PDF form) presented in a user interface. Refer for a moment to FIGS. 4A and 4B, which illustrate an example of a form used to input project data. As shown in FIG. 4A, a form 400 may include a variety of fields for entering project data. More specifically, the form 400 may include fields for typed text and numbers, dropdown boxes, radio buttons, etc. for entering project data, for example, project data associated with an initiative. In the example shown in FIG. 4A, the form 400 includes fields to select a direct report group for the initiative, a strategy that the initiative is advancing, a name of the initiative, a description of the initiative, a road map identifier linked to the initiative, a value type advanced by the initiative, a metric(s) (e.g., measure of success), and a planned completion date (first production launch) for the initiative.

Referring to FIG. 4B, the form 400 in this example may further include radio buttons or fields to identify a progress status of the initiative. In some other embodiments, the progress status may be obtained from a different source, such as a project management system or application. As further shown in FIG. 4B, the form 400 may include a field to specify an owner of the initiative, an NPA correlation, a VP organization, a performance management (PMG) value, narratives described success barriers, notes, and/or funding information.

Returning to FIG. 3, The process 300 also may include consolidating and storing the project data (block 320). For example, as described above with respect to the project data repository device 230, the data management and presentation system 130 may consolidate and/or centralize the project data in a single location (or, for some embodiments, in a virtual environment or the like that appears to be a single location), although various portions of the project data originate from various disparate data source devices 120. In some embodiments, the data management and presentation system 130 may structure and/or standardize the project data and store the standardized project data, e.g., in a data structure. In some embodiments, the data management and presentation system 130 may use an adapter or translator to convert the project data into a standardize and/or structured format.

In various embodiments, the process 300, or the operation for consolidating and storing the multi-level project data (e.g., the standardized project data) may alternatively, optionally, or additionally include an operation or function for determining connections and alignments between the initiatives represented in the multi-level project data, based on information in the stored multi-level project data (not shown in FIG. 3). In some such embodiments, the system 130 may determine that there is a connection(s) and/or alignment(s) between initiatives if the standardized data in a specific field or cell representing a first initiative matches, is the same type as, corresponds to, or has some other relationship with the standardized data in the same or similar field or cell for a second initiative(s). Various embodiments may use relationships between data in dissimilar fields to determine connection(s) and/or alignment(s).

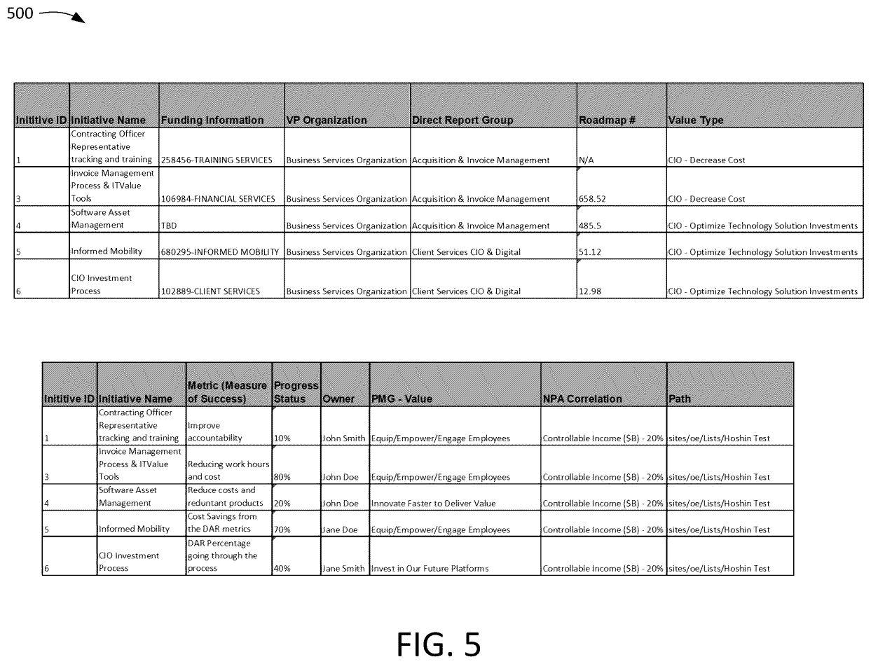

Refer now to FIG. 5, which illustrates an example of data structure that stores standardized project data. In FIG. 5, the intersection between rows and columns may be referred to as a field or cell—e.g., the cell at the intersection of the second row (the row for the initiative ID having the value “3” and the 6^{th} column labeled roadmap number contains the data “658.52”. In various embodiments, the original project data 1.1 (before being standardized) from various data source devices 120 may have been in disparate formats. For example, the original “value type” data for initiative 4 may have been in the format of a text string containing “CIO—O. T. S. I.”; the original “value type” data for initiative 5 may have been in the format of the integer “2” which represented ‘optimize technical solution investments’ within the data source device 120 for that sub-entity of the organization; and the original “value type” data for initiative 6 may have been in the format of the text string “Optimize Technical Solution Investments”. To standardize these three pieces of data (“CIO—O. T. S. I.”, “2”, “Optimize Technical Solution Investments”), the system 130 may determine that they all represent the same thing (e.g., using a look-up table or the like), convert them to the standard string “CIO—Optimize Technology Solution Investments” and store this standardized string data in the data structure 500, as shown in FIG. 5.

In the example of FIG. 5, the project data may be stored as entries in the data structure 500. In some embodiments, each entry in the data structure 500 may include information related to an initiative. In the example shown, the data structure may include an initiative ID that uniquely identifies an initiative, an initiative name, funding information for the initiative, an organization associated with the initiative (e.g., a vice president (VP) level organization), a direct report group, an identifier in a road map, a value type, a metric or measure of success for the initiative, a progress status of the initiative, an owner, a performance management (PMG) value, an NPA correlation, and a resource path for a database or repository that stores information for the initiative. In various fields or cells, the data structure 500 may store information identifying connections between different initiatives and their connections to different points in the organization. Further, the data structure 500 may store information identifying the value of each initiative to different points or levels in the organization, and a measure of success for each initiative.

Using the example shown in FIG. 5 for illustration, initiative #3 may be directed to reducing working hours and costs for the business services organization (which may be part of acquisition and invoice management). The value type for this initiative is “decrease cost” (i.e., cost reduction), with a performance management (PMG) value of improving the equipment, empowerment, and/or engagement of employees. By standardizing, structuring, and/or organizing the strategic planning project data within the data structure 500, e.g., in the manner shown in FIG. 5, the system 130 can use the data structure 500 to identify initiatives, their attributes, values, and connections to other entities, levels, and/or layers within the organization. As further described herein, the data stored in the data structure 500 may be filtered by the system 130 and visually represented and displayed in a Sankey diagram or a similar graphical representation that visually indicates the connections and alignments between the initiatives within an organization. Having all of the information graphically displayed in a single GUI allows a user to better understand the organization's strategic planning and to study, improve, and/or develop an existing or a new strategic plan (e.g., using a Hoshin Kanri process and/or other strategic planning process). In various embodiments, the manner in which the project data is standardized, structured and stored within the data structure 500 makes it possible for the system 130 to visually, graphically, display how different initiatives are linked or connected, and how lower level initiatives align with higher level and/or organization wide initiatives, goals, and objectives.

Returning to FIG. 3, the process 300 further may include receiving or otherwise obtaining user inputs for viewing the project data (block 330). For example, as described above with respect to the user input interface module 210, the data management and presentation system 130 may receive user inputs for generating various views or displays of the standardized project data (e.g., via the client device 110). In some embodiments, the user inputs may include: instructions to view connections between initiatives across various layers of an organization (e.g., in the form of a Sankey diagram), instructions to view details of an initiative (e.g., an initiative relating to a type of service provided by the organization) and instructions to “drill down” to view contributions and progress made by various groups involved in that initiative, as well as other attributes and/or details of the initiative (e.g., groups, owners, stakeholders of the initiatives, objectives of the initiative, progress completion of the initiative, etc.).

The process 300 also may include displaying the project data (block 340). For example, as described above with respect to the data display module 240, the data management and presentation system 130 may filter, organize, and/or present the project data based on the user input received via the user input interface module 210 within an application and/or web portal. The data display module 240 may generate display instructions based on the user input and display the project data via the client device 110 (e.g., via an application, web-portal, or the like). As one illustrative example, the project data may be presented or displayed in the form of a Sankey diagram that graphically identifies the connections and alignments between initiatives that are ongoing among different entities within the organization. Further, the user may continue to provide user inputs in an interactive session to display in different ways the connections and/or alignments between initiatives. In some embodiments, the data management and presentation system 130 may generate default views of the project data without receiving user input.

FIG. 6 illustrates an example of an interface 600 presenting multi-level project data in accordance with aspects of the present disclosure. In some embodiments, the interface 600 may present the project data processed by the data management and presentation system 130, e.g., by displaying it via the client device 110. In the embodiment shown in FIG. 6, the interface 600 may include a data filtering section 610 in which a user may provide user inputs or selections of data to filter. More specifically, the user may select to display or view connections between initiatives meeting certain criteria or attributes (e.g., initiatives associated with different departments, groups, strategies, correlations, completion progresses, etc.). Based on the user's selections, the data management and presentation system 130 may present or display (e.g., via the interface 600) a Sankey diagram 620 graphically illustrating the connections between initiatives and graphically illustrating how the initiatives align with each other with respect to different areas of the organization, different groups, different strategies, and different goals/objectives. The connections and/or alignments may be shown for different levels and layers in an organization.

In the example shown in FIG. 6, the Sankey diagram 620 illustrates an organization-wide strategic plan (e.g., developed using Hoshin Kanri and/or other strategic planning processes). More specifically, the Sankey diagram 620 illustrates connections between departments (on the left) and CIO strategies, connections between CIO strategies and PMG strategies, and connections between PMG strategies and correlations. In some embodiments, each level in the Sankey diagram 620 may include a composite or aggregation of initiatives in a preceding level. For example, the department “Business Services Organization” may include a composite of all initiatives within that department (e.g., as determined from the project data, for instance, as shown in FIG. 5), and “CIO—Strategy 1” may include a composite of all departments that contributed to that CIO strategy, (e.g., as determined from the project data).

In some embodiments, the user may select a particular data point on the Sankey diagram (e.g., a department, a strategy, etc.) and view the initiatives or composite initiatives associated with that data point, as well as the contributions made by each initiative. In this way, the user may use a single interface to see and investigate how individual initiatives or composite initiatives at different levels are aligned with higher level goals and objectives across the entire organization, and to see and investigate the contributions made by each initiative or composite initiative. In this way, underperforming and/or misaligned initiatives may be quickly identified, studied, and addressed.

In some embodiments, the user may interact with the interface 600 to select and filter the Sankey diagram by different initiatives or composite initiatives to study different areas and connections within the overall strategic plan represented by the Sankey diagram 620. By selecting different filters, the Sankey diagram may be updated to illustrate the selected connections across multiple levels in the organization. As described herein, the Sankey diagram may be ultimately generated based on the project data, which may be standardized, and which is stored by the data management and presentation system 130 after receipt from disparate data source devices 120. Thus, the user may quickly view connections and alignments of initiatives across the entire organization from a single interface, even when the underlying initiatives data originates from disparate data source devices 120. Further, the interface 600 may illustrate a measure of value contributed by each initiative to higher-level composite initiatives, and the types of values contributed.

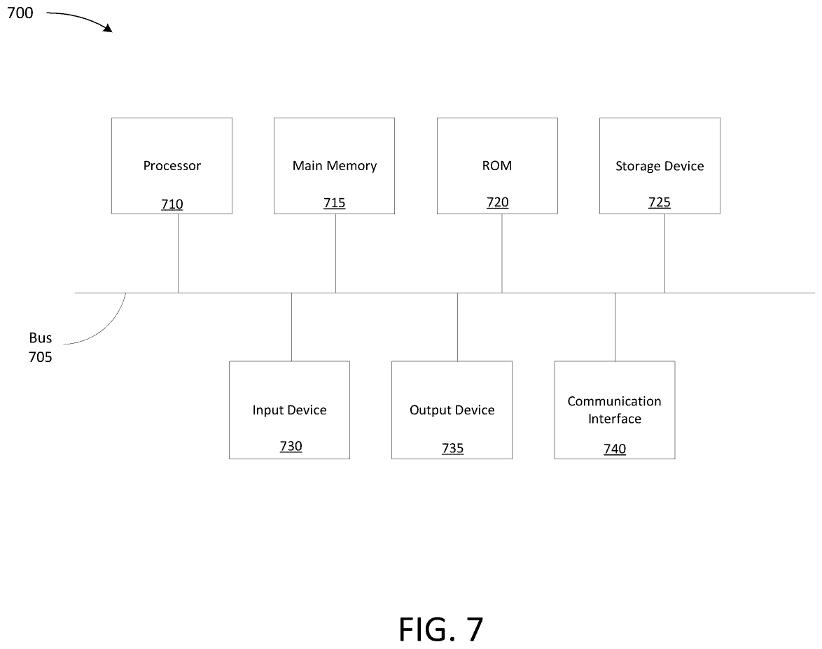

FIG. 7 illustrates example components of a device 700 that may be used within environment 100 of FIG. 1. Device 700 may correspond to the client device 110, the data source device 120, and/or the data management and presentation system 130. Each of the client device 110, the data source device 120, and/or the data management and presentation system 130 may include one or more devices 700 and/or one or more components of device 700. A computing system, such as the device 700 may be used to implement the process 300, various of the operations and functions of the process 300, and/or various of the operations and functions described throughout this disclosure.

As shown in FIG. 7, device 700 may include a bus 705, a processor 710, a main memory 715, a read only memory (ROM) 720, a storage device 725, an input device 730, an output device 735, and a communication interface 740.

Bus 705 may include a path that permits communication among the components of device 700. Processor 710 may include a processor, a microprocessor, an application specific integrated circuit (ASIC), a field programmable gate array (FPGA), or another type of processor that interprets and executes instructions. Main memory 715 may include a random-access memory (RAM) or another type of dynamic storage device that stores information or instructions for execution by processor 710. ROM 720 may include a ROM device or another type of static storage device that stores static information or instructions for use by processor 710. Storage device 725 may include a magnetic storage medium, such as a hard disk drive, or a removable memory, such as a flash memory.

Input device 730 may include a component that permits an operator to input information to device 700, such as a control button, a keyboard, a keypad, or another type of input device. Output device 735 may include a component that outputs information to the operator, such as a light emitting diode (LED), a display, or another type of output device. Communication interface 740 may include any transceiver-like component that enables device 700 to communicate with other devices or networks. In some implementations, communication interface 740 may include a wireless interface, a wired interface, or a combination of a wireless interface and a wired interface. In embodiments, communication interface 740 may receive computer readable program instructions from a network and may forward the computer readable program instructions for storage in a computer readable storage medium (e.g., storage device 725).

Device 700 may perform certain operations, as described in detail below. Device 700 may perform these operations in response to processor 710 executing software instructions contained in a computer-readable medium, such as main memory 715. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 715 from another computer-readable medium, such as storage device 725, or from another device via communication interface 740. The software instructions contained in main memory 715 may direct processor 710 to perform processes that will be described in greater detail herein. Alternatively, hardwired circuitry may be used in place of or in combination with software instructions to implement processes described herein. Thus, implementations described herein are not limited to any specific combination of hardware circuitry and software.

In some implementations, device 700 may include additional components, fewer components, different components, or differently arranged components than are shown in FIG. 7.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may include a system, a method, and/or a computer program product at any possible technical detail level of integration. The computer program product may include a computer readable storage medium (or media) having computer readable program instructions thereon for causing a processor to carry out or execute aspects and/or processes of the present disclosure.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In embodiments, a service provider could offer to perform the processes described herein. In this case, the service provider can create, maintain, deploy, support, etc., the computer infrastructure that performs the process steps of the disclosure for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A computer-implemented method for displaying multi-level project data, the method comprising:
receiving multi-level project data originating from a plurality of disparate data sources associated with a plurality of different entities within an organization, wherein the multi-level project data comprises information identifying initiatives performed by the plurality of different entities;
storing the multi-level project data in a data structure in a central repository;
determining connections and alignments between the initiatives across multiple levels within the organization based on the stored multi-level project data; and
displaying information identifying the determined connections and alignments between the initiatives across the multiple levels within the organization.

2. The method of claim 1, wherein the displaying the information identifying the determined connections and alignments comprises displaying an organization-wide strategic plan developed using a Hoshin Kanri strategic planning process.

3. The method of claim 1, wherein the displaying the information identifying the determined connections and alignments comprises displaying a Sankey diagram illustrating the determined connections and alignments.

4. The method of claim 3, further comprising:
receiving user inputs for filtering the multi-level project data based on one or more attributes; and
dynamically modifying an appearance of the Sankey diagram based on the user inputs.

5. The method of claim 1, further comprising:
receiving a user input comprising a selection of a data point included in the multi-level project data; and
presenting additional information regarding the data point.

6. The method of claim 1, further comprising standardizing the multi-level project data, wherein the storing the multi-level project data in the data structure comprises storing the standardized multi-level project data.

7. The method of claim 1, wherein the data structure comprises information identifying the connections and alignments between the initiatives across multiple levels within the organization, the information comprising at least one of:
an initiative name;
funding information;
a group name;
a roadmap identifier;
a value type;
a metric;
status information; or
owner information.

8. A computer program product comprising a computer readable storage medium having program instructions embodied therewith, the program instructions executable by a computing device to cause the computing device to perform operations comprising:
receiving multi-level project data originating from a plurality of disparate data sources associated with a plurality of different entities within an organization, wherein the multi-level project data comprises information identifying initiatives performed by the plurality of different entities;
storing the multi-level project data in a data structure in a central repository;
determining connections and alignments between the initiatives across multiple levels within the organization based on the stored centralized multi-level project data; and
displaying information identifying the determined connections and alignments between the initiatives across the multiple levels within the organization.

9. The computer program product of claim 8, wherein the displaying the information identifying the determined connections and alignments comprises displaying an organization-wide strategic plan developed using a Hoshin Kanri strategic planning process.

10. The computer program product of claim 8, wherein the displaying the information identifying the determined connections and alignments comprises displaying a Sankey diagram illustrating the determined connections and alignments.

11. The computer program product of claim 10, the operations further comprising:
receiving user inputs for filtering the multi-level project data based on one or more attributes; and
dynamically modifying an appearance of the Sankey diagram based on the user inputs.

12. The computer program product of claim 8, the operations further comprising:
receiving user inputs comprising a selection of a data point included in the multi-level project data; and
presenting additional information regarding the data point.

13. The computer program product of claim 8, the operations further comprising standardizing the multi-level project data, wherein the storing the multi-level project data in the data structure comprises storing the standardized multi-level project data.

14. The computer program product of claim 8, wherein the data structure comprises information identifying the connections and alignments between the initiatives across multiple levels within the organization, the data structure further comprising at least one of:
an initiative name;
funding information;
a group name;
a roadmap identifier;
a value type;
a metric;
status information; or
owner information.

15. A system comprising:
a processor;
a computer readable memory; and
a non-transitory computer readable storage medium operably connected to the processor, and containing program instructions that are executed by the processor to cause the processor to perform operations comprising:
receiving multi-level project data originating from a plurality of disparate data sources associated with a plurality of different entities within an organization, wherein the multi-level project data comprises information identifying initiatives performed by the plurality of different entities;
storing the multi-level project data in a data structure in a central repository;
determining connections and alignments between the initiatives across multiple levels within the organization based on the stored centralized multi-level project data; and
displaying information identifying the determined connections and alignments between the initiatives across the multiple levels within the organization.

16. The system of claim 15, wherein the displaying the information identifying the determined connections and alignments causes the computing device to perform operations comprising displaying an organization-wide strategic plan developed using a Hoshin Kanri strategic planning process.

17. The system of claim 15, wherein the displaying the information identifying the determined connections and alignments causes the computing device to perform operations comprising displaying a Sankey diagram illustrating the determined connections and alignments.

18. The system of claim 17, the operations further comprising:
receiving user inputs for filtering the multi-level project data based on one or more attributes; and
dynamically modifying an appearance of the Sankey diagram based on the user inputs.

19. The system of claim 15, the operations further comprising:
receiving user inputs comprising a selection of a data point included in the multi-level project data; and
presenting additional information regarding the data point.

20. The system of claim 15, the operations further comprising standardizing the multi-level project data, wherein the storing the multi-level project data in the data structure comprises storing the standardized multi-level project data.
